(19) United States
(12) Patent Application Publication
(10) Pub. No.: US 2003/0189567 A1
(43) Pub. Date: Oct. 9, 2003

(54) Viewing controller for three-dimensional computer graphics

(75) Inventor: Adam Michael Baumberg, Berkshire (GB)

Correspondence Address: FITZPATRICK CELLA HARPER & SCINTO, 30 ROCKEFELLER PLAZA, NEW YORK, NY, 10112, US

(73) Assignee: CANON EUROPA N.V., Amstelveen (NL)

(21) Appl. No.: 10/408,246

(22) Filed: Apr. 8, 2003

(30) Foreign Application Priority Data
Apr. 8, 2002 (GB) 0208070.3

(51) Int. Cl. G06T 15/00

(52) U.S. Cl. 345/419

(57) ABSTRACT

In a 3D graphics processing apparatus 2, a virtual camera 100 is controlled to view a 3D computer model 120 in accordance with user instructions. The virtual camera 100 is constrained to move to different positions on a sphere around the 3D computer model in accordance with user instructions while having a viewing direction towards the centre of the sphere. In addition, processing apparatus 2 controls the camera in dependence upon the angle between the viewing direction of the camera and the up-axis of the 3D computer model such that (i) when the viewing direction of the camera and the up-axis of the computer model are perpendicular, the camera is controlled to cause the up-axis of the computer model to be parallel to the camera up-axis, (ii) when the viewing direction of the camera and the up-axis of the computer model are parallel, the camera is not controlled to constrain the relative directions of the camera up-axis, and the computer model up axis, and (iii) when the angle between the viewing direction of the camera and the up-axis of the computer model is between 0 and 90 degrees, the relative rotation of the camera and computer model is contained by an amount dependent upon the cosine of the angle.

This application claims the right of priority under 35 USC § 119 based on British patent application number GB 0208070.3, filed Apr. 8, 2002, which is hereby incorporated by reference herein in its entirety as if fully set forth herein.

The present invention relates to the field of three-dimensional (3D) computer graphics, and more particularly to the control of a camera to view a three-dimensional computer model.

3D computer models are viewed using a virtual camera having fixed or user-variable viewing parameters (focal length, field of view, etc). To control the view displayed, the user is able to change the relative position and orientation of the camera and the 3D computer model (either by translating and rotating the camera and/or by translating and rotating the 3D computer model—the effect is the same). In this way, the user can control the position and the viewing direction of the camera relative to the model.

Often, for ease of use, 3D computer graphics systems constrain the camera to have a viewing direction towards a predetermined point on the computer model and constrain the camera to move on a sphere having the predetermined point as its centre (the size of the model in the displayed image being controlled by the user zooming the camera or moving the camera towards or away from the object to change the size of the sphere). In this way, the system ensures that the view displayed to the user always contains the 3D computer model, and the user cannot get lost in 3D space because the camera cannot see the model.

For convenience, changes to the position of the camera are typically effected by the user by inputting camera control signals to the 3D graphics processing apparatus using an input device such as a mouse, touch-pad, tracker ball, pressure-sensitive nipple, joy-stick etc. For example, holding down a mouse button and moving the mouse vertically in the 2D horizontal plane on a desk, etc (or making corresponding movements with another type of input device) causes the camera to move so that the 3D model rotates (spins) about a horizontal axis in the displayed image, the direction of rotation being dependent upon the direction of the mouse movement. This is achieved by changing the elevation of the camera viewing position either up or down on the sphere. Similarly, holding down a mouse button and moving the mouse horizontally (or making corresponding movements with another type of input device) causes the camera to move so that the 3D model rotates about a vertical axis in the displayed image. Again, this is achieved by moving the camera viewing position around the 3D model, with the direction of the movement being determined by the direction of the mouse movement. This type of camera control is known as “unconstrained” control.

However, one problem which arises with this type of unconstrained camera control is that it is very difficult for the user to move the mouse in a purely vertical direction or in purely horizontal direction (or to make the corresponding movements with another type of input device). Consequently, this can result in undesirable rotation of the 3D model in the displayed image such that the vertical “up” axis of the 3D model departs from the vertical image axis without the user wanting this to happen. In practice, this is caused by a revolution of the camera relative to the 3D model (that is, rotation of the camera or object about the viewing direction axis of the camera).

To address this problem, some 3D graphics processing apparatus constrain the camera to move so that the vertical “up” axis of the 3D computer model always lies in the same plane as the camera “up” axis and always points upwards in the image. This is achieved by preventing relative revolution of the camera and 3D model (that is, preventing relative rotation about the camera's viewing direction axis). Such camera control is known as “constrained” control because the user does not have full control of the camera. However, this type of viewing control suffers from different problems. In particular, if the user tries to rotate the 3D model vertically (that is, about a horizontal axis) the camera reaches a maximum elevation and then spins itself (due to the constraint that the “up” axis of the 3D model must always point upwards in the image). The result of this is that the user can spin the 3D model 360 degrees about a vertical axis but not 360 degrees about a horizontal axis, which can be confusing for the user when trying to view the 3D model.

The present invention has been made with these problems in mind.

According to the present invention, the relative rotation of a viewing camera and a three-dimensional computer model is controlled in accordance with user instructions, but additional constraints are applied by the apparatus. The additional constraints are such that, when the user instructs a viewing direction of the camera perpendicular to the up axis of the three-dimensional coordinate system in which the computer model is defined, then the camera is controlled to force the up direction in the images displayed to the user to be in the same direction (or in the opposite direction) as the coordinate system up axis. However, when the user instructs a camera viewing direction parallel to the up axis of the three-dimensional coordinate system, then no additional constraints are applied.

Preferably, for camera viewing directions between perpendicular to and parallel to the up axis of the coordinate system, additional constraint is applied, with the amount of constrain increasing as the angle between the camera viewing direction and the up axis of the coordinate system increases from 0 degrees to 90 degrees.

By performing viewing control in this way, the user can cause the computer model displayed in images to spin about the computer model's up axis without the up axis deviating from vertical in the images. In addition, the user can cause the computer model displayed in images to spin about a horizontal axis so that the model is displayed inverted.

The present invention also provides a computer program product for configuring a programmable processing apparatus to operate in the way described above.

Embodiments of the invention will now be described, by way of example only, with reference to the accompanying drawings, in which like reference numbers are used to designate like parts, and in which:

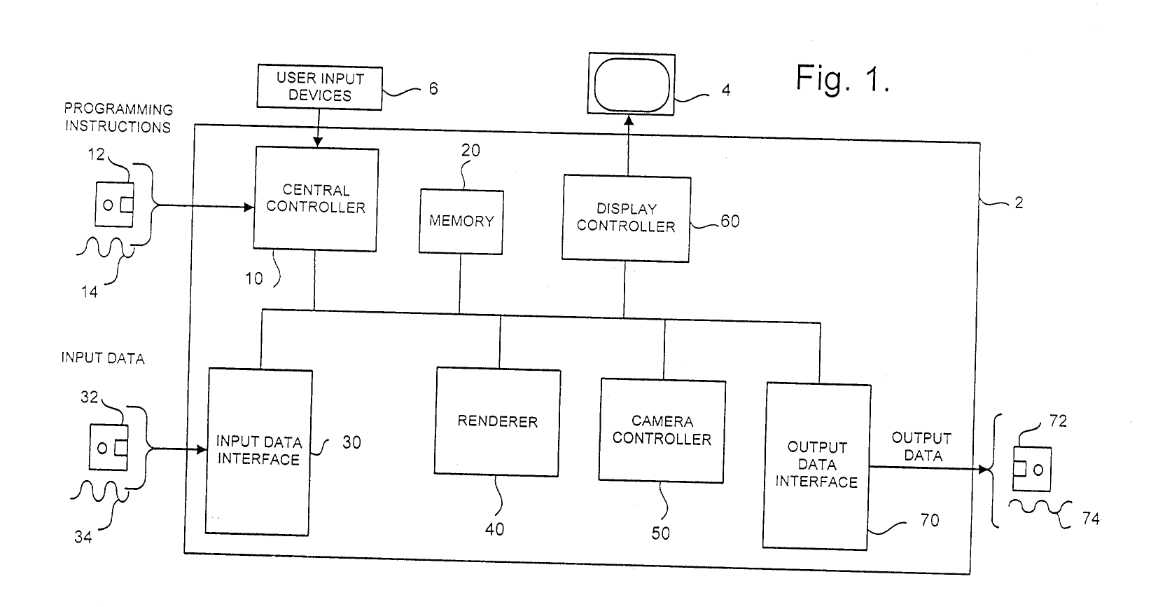

FIG. 1 schematically shows the components of an embodiment of the invention, together with the notional functional processing units into which the processing apparatus component may be thought of as being configured when programmed by programming instructions;

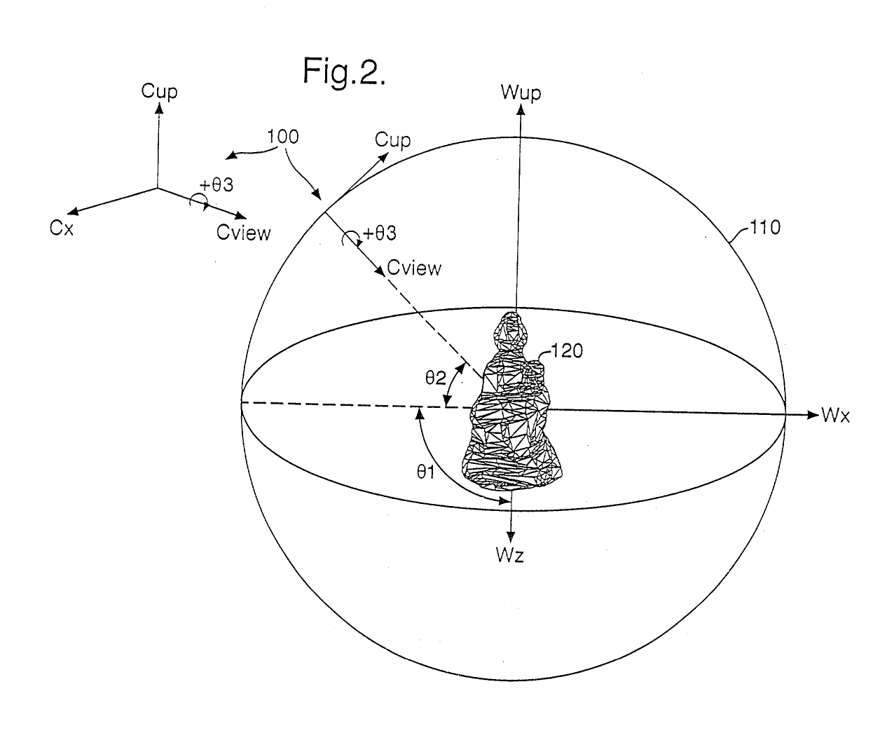

FIG. 2 illustrates how parameters are defined for a virtual camera to view a three-dimensional computer model, and the relationship between the camera parameters and the three-dimensional world coordinate system in which the 3D computer model is defined;

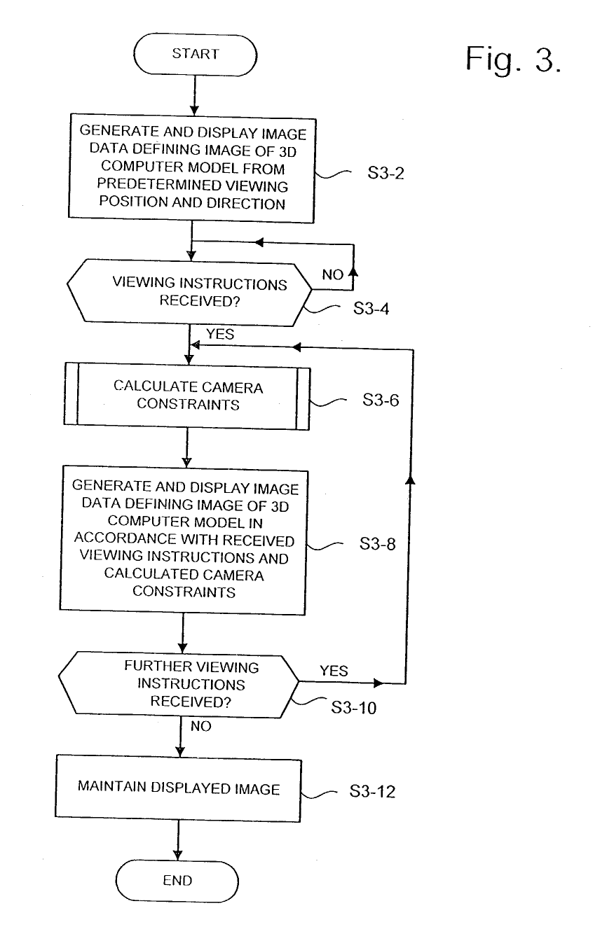

FIG. 3 shows the processing operations performed by the processing apparatus in FIG. 1;

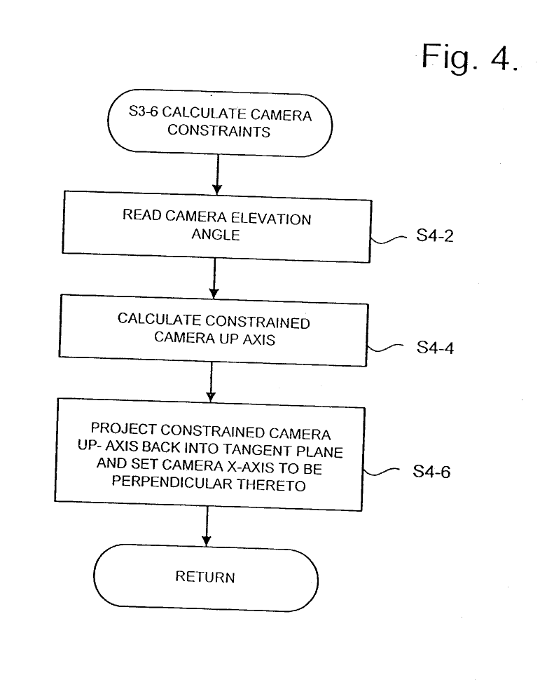

FIG. 4 shows the processing operations performed at step S3-6 in FIG. 3;

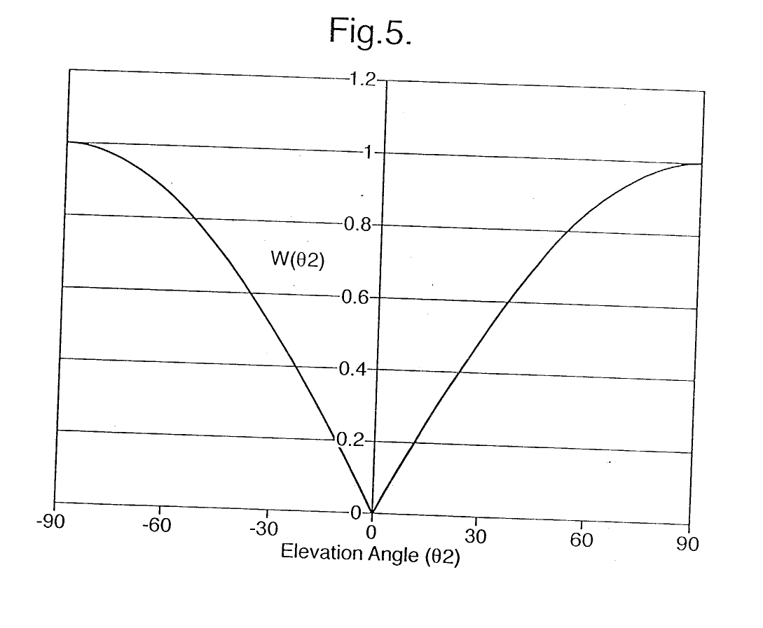

FIG. 5 shows a plot of the function “w(θ2)” used in the processing at step S4-4;

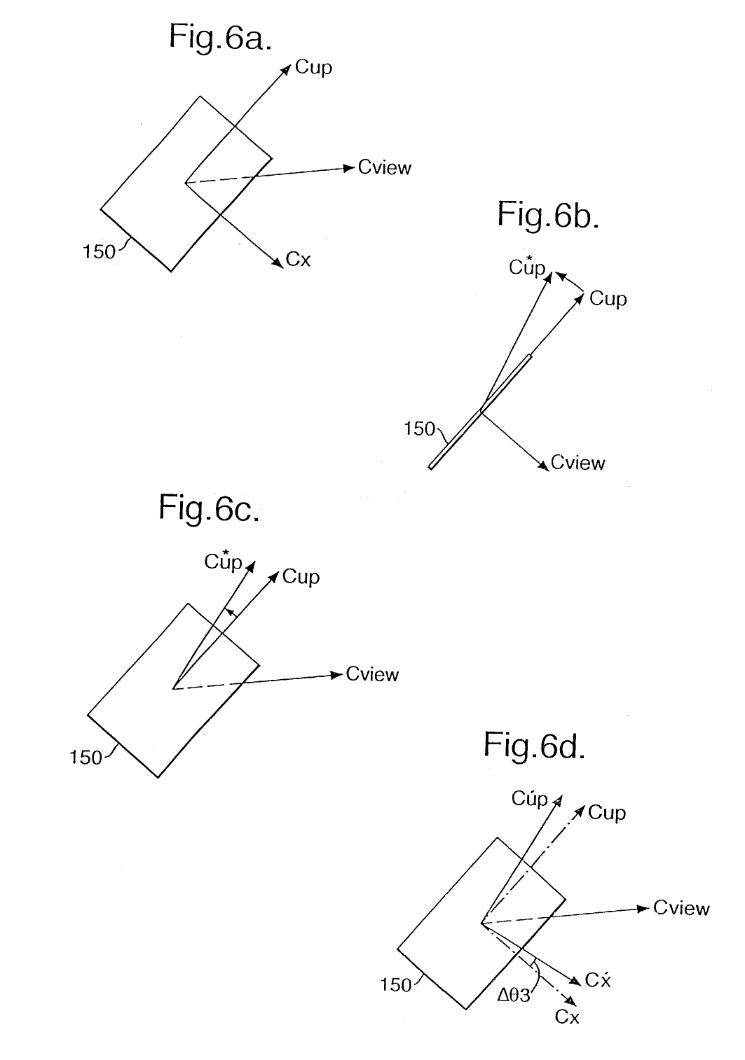

FIGS. 6a, 6b, 6c and 6d illustrate the effect of the processing performed at steps S4-4 and S4-6 in FIG. 4;

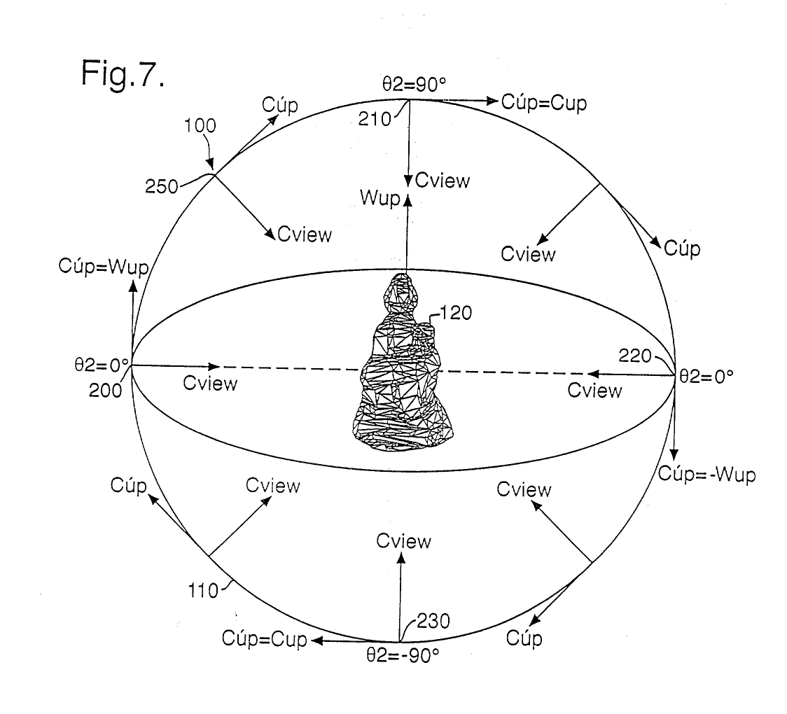

FIG. 7 shows an example to illustrate the effect of the viewing control performed by the apparatus in FIG. 1 for different camera elevations;

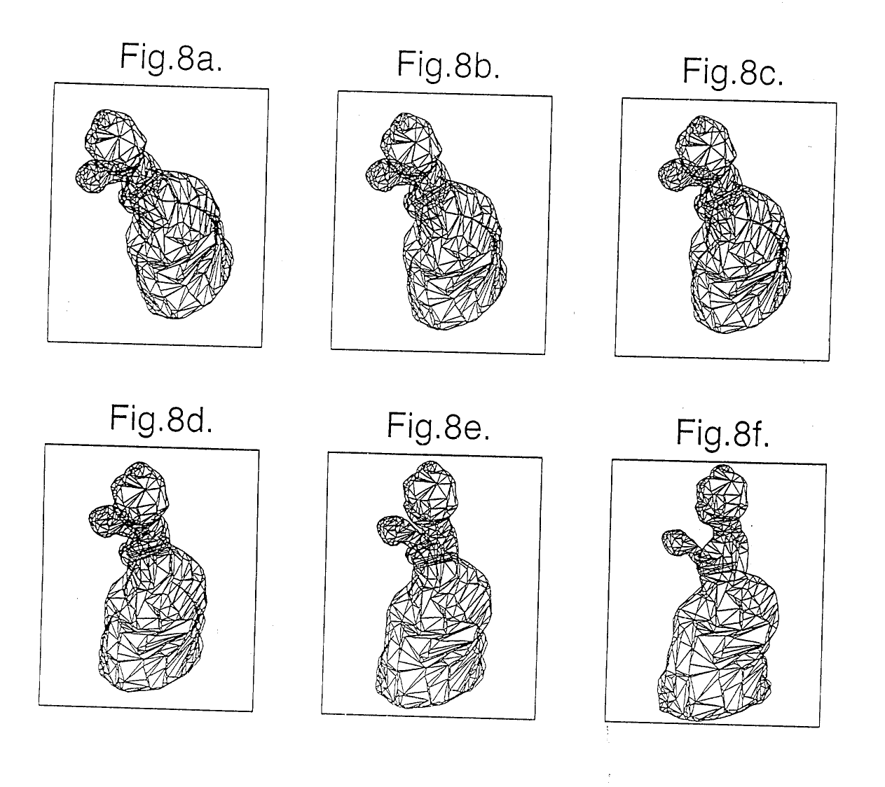

FIGS. 8a-8f show an example of the images displayed to a user when a camera with 45 degrees revolution angle is moved so that its elevation is reduced from 45 degrees to 0 degrees; and

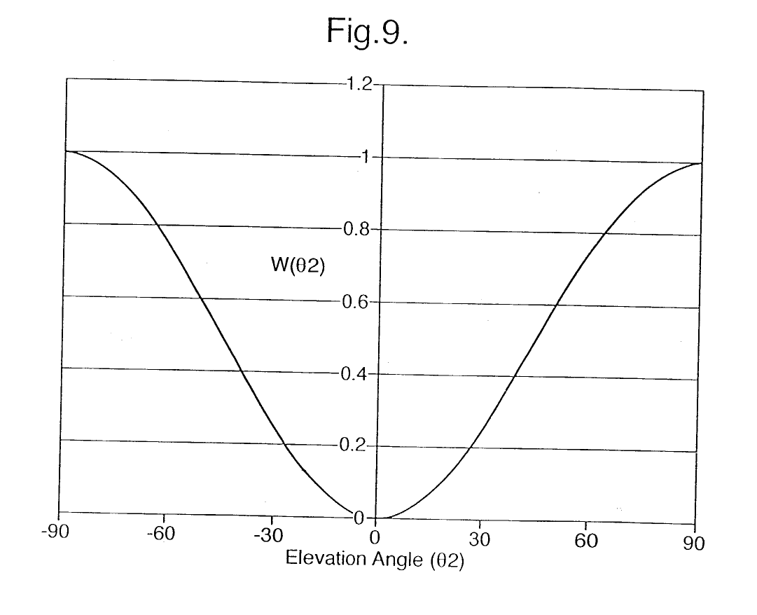

FIG. 9 shows an example of an alternative function “w(θ2)” which could be used in the processing at step S4-4 in FIG. 4.

Referring to FIG. 1, an embodiment of the invention comprises a processing apparatus 2, such as a personal computer (PC), containing, in a conventional manner, one or more processors, memories, graphics cards etc. A display device 4, such as a conventional personal computer monitor is provided, together with one or more user input devices 6, such as a keyboard, mouse, touch-pad, tracker ball, pressure-sensitive nipple etc.

The processing apparatus 2 is programmed to operate in accordance with programming instructions input, for example, as data stored on a data storage medium such as a disk 12 and/or as a signal 14. The signal 14 may be input to the processing apparatus 2, for example from a remote database, by transmission over a communication network (not shown) such as the Internet or by wireless transmission through the atmosphere, and/or entered by a user using a user input device 6 such as a keyboard.

As will be described in more detail below, the programming instructions comprise instructions to cause the processing apparatus 2 to become configured to control a virtual camera in accordance with user instructions, but in a partially constrained way. More particularly, processing apparatus 2 performs control in accordance with the programming instructions so that, when the camera is positioned to view the 3D computer model from the side (that is, the elevation angle of the camera is 0 degrees) the “up” axis of the camera is parallel to the “up” axis of the 3D computer model so that the “up” axis of the 3D computer model is vertical (either up or down) in the image displayed to the user. However, when the camera viewing position is at an elevation of 90 degrees (that is, the camera is looking directly down at the top of the 3D computer model or directly up at the bottom of the 3D computer model, then no viewing constraints are applied and that the user can control the camera in any desired way. For camera viewing position elevations between 0 degrees and 90 degrees, processing apparatus 2 constrains the viewing camera in such a way that the amount of constraint applied is interpolated between the no constraint condition of 90 degrees elevation and the full constraint condition of 0 degrees elevation, depending upon the actual elevation angle of the camera.

By performing processing in this way, processing apparatus 2 provides a constrained camera control system which addresses the problem in unconstrained systems that the vertical “up” axis of the 3D computer model departs from the vertical image axis without the user wanting this to happen, and also addresses the problem in previous constrained systems that the user cannot rotate the 3D computer model through 360 degrees about a horizontal axis.

When programmed by the programming instructions, processing apparatus 2 can be thought of as being configured as a number of functional units for performing processing operations.

Examples of such functional units and their interconnections are shown in FIG. 1. The units and interconnections illustrated in FIG. 1 are, however, notional and are shown for illustration purposes only to assist understanding; they do not necessarily represent units and connections into which the processor(s), memory etc of the processing apparatus 2 actually become configured.

Referring to the functional units shown in FIG. 1, a central controller 10 is arranged to process inputs from the user input devices 6 and to provide control and processing for the other functional units.

Memory 20 is provided for use by central controller 10 and the other functional units.

Input data interface 30 is arranged to control the storage of data input to the processing apparatus 2 on a data storage medium, such as disk 32, or as a signal 34. This data includes data defining a 3D computer surface shape model of one or more objects and data defining one or more texture maps for the 3D computer model.

Renderer 40 is arranged to generate data defining an image of the 3D computer model in accordance with a virtual camera, the processing performed by renderer 40 being conventional rendering processing.

Camera controller 50 is responsive to instructions input by a user using a user input device 6, to control in a constrained way the virtual camera used by renderer 40 to generate images of the 3D computer model.

Referring to FIG. 2, in this embodiment, camera controller 50 controls a virtual camera 100 to move on a sphere 110 in the three-dimensional world space coordinate system Wup, Wx, Wz, with the 3D computer model 120 to be viewed positioned at the centre of the sphere 110. In this embodiment, the centre of the sphere 110 is defined to lie at the origin of the world space coordinate system. The up direction of the world coordinate system and of the 3D computer model 120 is defined by the axis Wup.

Three axes Cview, Cup and Cx define the coordinate system of camera 100. Cview defines the viewing direction of camera 100. In this embodiment, Cview always points towards the centre of the sphere 110. Cup defines the vertical “up” axis of camera 100, that is the axis which defines the vertical up direction in the image data generated by renderer 40 and displayed to the user. Cup lies in a tangent plane to the sphere 110. Cx is a third axis defined to be perpendicular to Cview and Cup in a left-handed coordinate system. Cx therefore lies in the same tangent plane to the sphere 110 as the axis Cup.

The viewing position of camera 100 on the sphere 110 is defined by a horizontal azimuth angle θ1 and a vertical elevation angle θ2. In this embodiment, azimuth angle θ1 is defined from the positive z-coordinate axis Wz of the 3D world space. Elevation angle θ2 is defined from a line perpendicular to the vertical world space axis Wup (that is, a line lying in the plane defined by the x- and z-coordinate axes Wx and Wz).

The revolution of the camera about the viewing direction axis Cview is defined by a revolution angle θ3, with rotation in a clockwise direction when viewed along the Cview axis towards the origin of the camera coordinate system being positive.

In this embodiment, camera controller 50 performs processing to allow the user to change the azimuth angle θ1, the elevation angle θ2 and the revolution angle θ3. More particularly, after pointing and clicking on a first control button displayed on display device 4 (for example labelled “spin”) the user is able to change the azimuth angle θ1 by holding down the mouse button and moving the mouse in a “horizontal” (sideways) direction (or by performing corresponding operations with a different user input device 6), and is able to change the elevation angle θ2 by holding down the mouse button and moving the mouse in a “vertical” (up and down) direction (or by performing corresponding operations with a different user input device 6). After pointing and clicking on a second control button displayed on display device 4 (for example labelled “revolve”), the user is able to change the revolution angle θ3 by holding down the mouse button and moving the mouse (or by performing corresponding operations with a different user input device 6).

Referring again to FIG. 1, display controller 60 is arranged to control display device 4 to display the image data generated by renderer 40 showing the images of the 3D computer model.

Output data interface 70 is arranged to output data from processing apparatus 2 comprising the image data generated by renderer 40. The data may be output from the apparatus, for example, as data on a data storage medium, such as disk 72, and/or as a signal 74. A recording of the output data may be made by recording the output signal 74 either directly or indirectly using recording apparatus (not shown).

Referring now to FIG. 3, the processing operations performed by processing apparatus 2 will be described in detail.

At step S3-2, renderer 40 generates image data defining an image of the 3D computer model 120 from a predetermined camera viewing position and direction, and display controller 60 controls display device 4 to display the image to the user.

In this embodiment, renderer 40 is arranged to generate the image data at step S3-2 for a camera position with 0 degrees azimuth angle θ1 and 0 degrees elevation angle θ2, so that the camera viewing direction Cview is pointing along the z-coordinate axis of the three-dimensional world space towards the origin thereof.

At step S3-4, central controller 10 determines whether viewing instructions have been received from a user—that is, whether signals defining viewing instructions have been received from a user input device 6.

As soon as processing apparatus 2 receives user-input instructions defining a change in the azimuth angle θ1, elevation angle θ2 or revolution angle θ3, then processing proceeds to step S3-6.

At step S3-6, camera controller 50 calculates constraints to be applied to the viewing instructions defined by the user-input signals received at step S3-4. In this embodiment, the camera constraints calculated at step S3-6 comprise a revolution angle θ3 to be applied to camera 100, with the size and direction of revolution angle θ3 being dependent upon the angle between the viewing direction axis Cview of camera 100 and the world space up axis Wup, and consequently upon the elevation angle θ2 of camera 100.

FIG. 4 shows the processing operations performed by camera controller 50 at step S3-6.

Referring to FIG. 4, at step S4-2, camera controller 50 reads the elevation angle θ2 of the viewing position of the camera 100 from which an image is to be generated.

At step S4-4, camera controller 50 performs processing to calculate a constrained direction for the camera up-axis Cup which no longer lies in a tangent plane to the sphere 110.

More particularly, camera controller 50 performs the following calculations:

w(θ2)=|Cview·Wup| (1)

i=SIGN (Cup·Wup) (2)

C*up=(1−w)(i×Wup)+wCup (3)

where

Cview is the camera viewing axis, Cup is the camera up axis, and Wup is the world space up axis (described above with reference to FIG. 2);

“·” represents a dot product operation;

SIGN represents an operation to determine the algebraic sign (“+” or “−”) of the value; and

C*up represents a camera up axis which no longer lies in a tangent plane to the sphere 110.

The value of “w” defined by equation (1) above therefore varies as a function of the angle between the camera viewing axis Cview and the world space up axis Wup. Consequently, because Wup is fixed, the value of “w” varies as a function of the elevation angle θ2 of the camera 100. More particularly, in this embodiment, the value of “w” varies in dependence upon the cosine of the angle between the camera viewing axis Cview and the world up axis Wup (and therefore the sine of the angle θ2).

FIG. 5 shows how the value of “w” varies for all possible elevation angles (that is, −90 degrees to +90 degrees).

Referring to FIG. 5, it will be seen that the function w(θ2) has the properties that it is a continuous function which is symmetric about 0 degrees elevation (that is, the values of “w” for elevation angles from 0 degrees to +90 degrees are the same as the values of “w” for elevation angles from 0 degrees to −90 degrees). The function w(θ2) is also smooth for elevation angles between 0 degrees and +90 degrees and between 0 degrees and −90 degrees.

FIG. 6 illustrates the effect of performing the processing operations at step S4-4.

Referring to FIG. 6, FIG. 6a shows the initial positions of the camera axes Cview, Cup and Cx prior to the processing operations at step S4-4 being performed. As explained previously, in this state, the camera viewing direction Cview points along a radius of the sphere 110, and the camera up axis Cup and x-axis Cx lie in a tangent plane 150 to the sphere 110.

Referring to FIGS. 6b and 6c, the effect of performing the calculations in equations (1) to (3) above is that the camera up axis Cup is pulled out of the tangent plane 150 towards the direction of the world space up axis Wup (illustrated in FIG. 6b) and is rotated within its new plane again towards the world up axis direction Wup (illustrated in FIG. 6c) to give a constrained camera up axis C*up. The angular movement of the camera up axis Cup is determined in dependence upon the value of “w” defined by equation (1) above, and is therefore dependent upon the elevation angle θ2 of the camera 100.

Referring again to FIG. 4, step S4-6, camera controller 50 projects the constrained camera up axis C*up calculated at step S4-4 back into the tangent plane 150 and sets the camera x-axis Cx to be perpendicular to the projected camera up axis in the tangent plane 150.

In this embodiment, camera controller 50 performs the processing at step S4-6 as follows:

(i) Calculate C*up·Cview to give a scalar value.

(ii) Multiply the scalar value by Cview to give a vector.

(iii) Subtract the calculated vector from C*up to give a projection, C′up, of the camera up axis back into the tangent plane 150.

The effect of the processing at step S4-6 is illustrated in FIG. 6d.

Referring to FIG. 6d, the projected camera up axis C′up is rotated from the original camera up axis Cup in the tangent plane 150. Consequently, the new camera x-axis C′x is rotated by the same angle from the original camera x-axis Cx. The camera viewing direction Cview remains unchanged. Consequently, the angle of rotation Δθ3 of the camera x-axis from Cx to C′x defines an additional revolution of the camera 100 from its original revolution angle θ3.

By performing the processing in the way described above, camera controller 50 revolves the camera 100 around its viewing direction axis Cview. It should be noted, however, that the processing operations performed at steps S4-4 and S4-6 have no effect if, prior to performing the processing operations, camera 100 had a revolution angle θ3 of 0 degrees. More particularly, if θ3 is 0 degrees, then the processing performed at step S4-4 rotates the camera up axis Cup out of the tangent plane 150 towards the direction of the world up axis Wup (as shown in FIG. 6b) but, because there is no camera revolution, the processing does not rotate the camera up axis within its new plane as shown in FIG. 6c. Consequently, when the processing is performed at step S4-6, the camera up axis C*up projects back into the tangent plane 150 to give an up axis C′up which lies in the same direction as the previous camera up axis Cup. In other words, C′up is equal to Cup if θ3 is 0 degrees.

Referring again to FIG. 3, at step S3-8, renderer 40 performs rendering processing to generate image data in accordance with the camera viewing position defined by the instructions received from the user at step S3-4 and the camera revolution angle calculated by camera controller 50 at step S3-6. Display controller 60 then controls display device 4 to display the generated image data to the user in real-time.

At step S3-10, central controller 10 determines whether further viewing instructions have been received from the user. Steps S3-6 to S3-10 are repeated in real-time as new viewing instructions are input by the user.

When it is determined at step S3-10 that no further viewing instructions have been received from the user, then, at step S3-12, display processor 60 controls display device 4 to maintain the currently displayed image.

Equations (1), (2) and (3) above show that, when the camera viewing direction Cview is at 90 degrees to the world up axis Wup (that is, when the elevation angle θ2 of the camera viewing position is 0 degrees) then either:

C′up=Wup (4)

C′up=Wup (5)

Equation (4) holds if equation (2) defines “i” to be positive, while equation (5) holds if equation (2) defines “i” to be negative.

The effect of this is that, for camera viewing positions with an elevation angle θ2 of 0 degrees, camera controller 50 causes the camera up axis to be parallel to the world up axis, so that the 3D computer model 120 appears either vertically up or vertically down in the displayed image.

On the other hand, when the camera viewing direction Cview is parallel to the world up axis Wup (that is, when the camera viewing position has an elevation θ2 of +90 degrees or −90 degrees), then:

C′up=Cup (6)

The effect of equation (6) is that camera controller 50 does not apply any constraints to the camera up axis for viewing position elevation angles of +90 degrees or −90 degrees, with the result that the user has complete control of the camera 100. Consequently, the user can control the camera 100 so that, in effect, the 3D computer model 120 spins through 360 degree about an axis which is horizontal in the three-dimensional world space (with consequent inversion of the 3D computer model in the displayed images).

FIG. 7 summarises the effect of the processing performed by camera controller 50 for different elevation angles θ2 of the viewing position of camera 100.

For simplicity, the camera axis Cx is not shown in FIG. 7. However, as described previously, Cx is defined to be perpendicular to the camera up axis C′up and camera viewing axis Cview in a left-handed coordinate system.

Referring to FIG. 7, for camera viewing position 200 the elevation angle θ2 is 0 degrees and the camera viewing direction Cview therefore provides a horizontal side view of the 3D computer model 120. In this case, the constrained camera up axis C′up is in the same direction as the world up axis Wup in accordance with equation (4) above. Consequently, if the user now holds down the mouse button and moves the mouse horizontally (or performs corresponding operations with a different type of user-input device 6) to change the azimuth angle θ1 of the camera 100, then the 3D computer model 120 spins about the world up axis Wup in the images displayed to the user, and the up axis of the 3D computer model 120 does not derivate from vertical in the displayed images.

As the camera viewing position is moved in a clockwise direction (when looking at FIG. 7) between elevation angles of 0 degrees and +90 degrees, the constrained camera up axis C′up is given by equation (3) above. In this way, as the elevation angle θ2 increases (and therefore, the angle between Cview and Wup decreases), the degree to which camera controller 50 constrains the camera up axis is smoothly and gradually reduced from full constraint at 0 degrees elevation (in which the camera up axis is forced to be equal to the world up axis) and no constraint at 90 degrees. The amount of constraint is determined by equation (1) above, which defines the value of the variable “w” as a function of the cosine of the angle between Cview and Wup (and therefore the sine of the elevation angle θ2).

At viewing position 210 (that is, +90 degrees elevation) camera controller 50 does not apply any constraint to the camera up axis so that the constrained camera up axis C′up is equal to the user-defined camera up axis Cup in accordance with equation (6) above. Consequently, as illustrated in FIG. 7, the user is able to move the camera 100 through viewing position 210 without the problem encountered in traditional constrained viewing systems that the camera is forced to revolve to maintain the world up axis Wup in an upright orientation in the image displayed to the user.

For camera viewing positions between position 210 and position 220, camera controller 50 constrains the camera up axis in accordance with equation (3) above. In the example shown in FIG. 7, the camera 100 is inverted for viewing positions between position 210 and position 220, with the result that the 3D computer model 120 will appear inverted in the image displayed to the user on display device 4.

At viewing position 220, camera controller 50 applies full constraint to the camera up axis, so that the constrained camera up axis C′up is given by equation (5) above. That is, the constrained camera up axis is in the opposite direction to the world up axis Wup.

For negative elevation angle viewing positions between position 220 and position 230 and between position 230 and position 200, camera controller 50 controls the camera up axis in the same way as described above for positive elevation viewing angle positions.

Referring now to FIG. 8, the effect of the processing performed by viewing controller 50 will be illustrated for an example in which the user moves the camera viewing position from position 250 shown in FIG. 7 to position 200 (that is, from a viewing position with 45 degrees elevation to a viewing position with 0 degrees elevation). For the purpose of the example, it is assumed that the camera has a revolution angle θ3 of 45 degrees at viewing position 250.

Referring to FIG. 8, FIG. 8a shows the image displayed to the user on display device 4 when the camera 100 is at viewing position 250. As noted above, in this viewing position, the camera 100 has an elevation angle θ2 of 45 degrees and a revolution angle θ3 of 45 degrees.

FIG. 8f shows the image displayed to the user on display device 4 when the camera is at viewing position 200. In this viewing position, the camera 100 has an elevation angle θ2 of zero degrees and camera controller 50 has therefore constrained the camera up axis to be equal to the world up axis Wup in accordance with equation (4) above (that is camera controller 50 has constrained the revolution angle θ3 to be 0 degrees). Consequently, the image shown in FIG. 8f represents a horizontal side view of the 3D computer model 120 in which the 3D computer model 120 is vertically upright.

FIGS. 8b, 8c, 8d and 8e show how the image displayed to the user on display device 4 changes as the user moves the camera from viewing position 250 to viewing position 200. More particularly, view controller 50 controls the camera up axis in accordance with equation (3) above so that the effect is that the revolution angle θ3 of the camera 100 gradually reduces from 45 degrees at viewing position 250 to 0 degrees at viewing position 200. This can be seen from the gradual rotation of the subject object 120 to an upright position in FIGS. 8a to 8f.

Many modifications and variations can be made to the embodiment described above within the scope of the claims.

For example, in the embodiment above, the user is able to change the revolution angle θ3 of the camera 100. However, this user-control is not essential and may be omitted.

In the embodiment described above, no facility is provided for the user to zoom the camera 100 (or change the distance between the camera 100 and the 3D computer model 120). However, such a facility may be provided by processing apparatus 2.

In the embodiment described above, changes to the view of the 3D computer model 120 are effected by moving the camera 100 while the 3D computer model 120 remains stationary. However, instead, the 3D computer model 120 may be rotated while the camera 100 remains stationary.

In the embodiment described above, the degree of constraint exerted on the camera up axis Cup by view controller 50 is determined by the function w(θ2) given by equation (1) above. However, different functions of w(θ2) may be used instead. An Example of such an alternative function is shown in FIG. 9. Preferably, the function w(θ2) is continuous and also symmetric for positive and negative elevation angles.

In the embodiment described above, processing apparatus 2, performs processing to provide the user with control to change the revolution angle θ3 of the camera 100. In addition, view controller 50 performs control to change automatically the revolution angle θ3 in accordance with the constraint applied to the camera up axis. However, this automatic change of revolution angle θ3 may conflict with user-requested changes of revolution angle θ3 and/or may be confusing for the user. Consequently, view controller 50 may be arranged to perform processing so that, when the user changes the revolution angle θ3 of camera 100, no constraint is applied to the camera up axis Cup unless the elevation angle θ2 of the camera 100 is within a predetermine small angle of 0 degrees and/or the camera up axis Cup is within a predetermined small angle of the world up axis Wup. When arranged in this way, once the camera elevation angle θ2 is within the predetermined angle of 0 degrees and/or the camera up axis is within the predetermined angle of the world up axis Wup, then view controller 50 applies constraints to the camera up axis Cup in accordance with equation (1) above.

In the embodiments described above, processing is performed by a programmable computer using processing routines defined by programming instructions. However, some, or all, the processing could, of course, be performed using hardware.

1. A method of controlling the view of a three-dimensional computer model from a virtual camera, the method being performed by a processing apparatus and comprising:
receiving user instructions to change the view; and
rotating the virtual camera and computer model relative to each other in accordance with the user instructions and performing additional control of the relative rotations such that:
whenever the viewing direction of the camera and the up axis of the computer model are perpendicular, the up axis of the computer model is constrained to be parallel to the camera up axis; but
whenever the viewing direction of the camera and the up axis of the computer model are parallel, no additional control of the relative rotations is performed.

2. A method according to claim 1, wherein the additional control of the relative rotations is performed so that the up axis of the camera is constrained towards being parallel to the up axis of the computer model by an amount dependent upon the angle between the viewing direction of the camera and the up axis of the computer model.

3. A method according to claim 2, wherein the additional control is performed so that the constraint increases continuously as the angle between the viewing direction of the camera and the up axis of the computer model increases.

4. A method according to claim 2, wherein the amount of the constraint is calculated in dependence upon the cosine of the angle between the viewing direction of the camera and the up axis of the computer model.

5. A method according to claim 1, wherein the additional control of the relative rotations is performed by changing the relative rotation of the camera and computer model about the viewing direction of the camera.

6. A method of controlling the relative position and orientation of a virtual camera and a three-dimensional computer model, the method being performed by a processing apparatus, and comprising:
rotating the virtual camera and computer model relative to each other in accordance with user instructions; and
controlling the relative rotation of the camera and computer model such that:
the user can cause the computer model to spin in displayed images about the up axis of the computer model without the up axis of the computer model deviating from the vertical direction in the images; and
the user can cause the computer model to spin in displayed images about an axis perpendicular to the up axis of the computer model so that the computer model inverts in the images.

7. A method of controlling a virtual camera to view a three-dimensional computer model from different positions in accordance with user instructions in a three-dimensional computer graphics processing apparatus, the method being performed by the processing apparatus and comprising:
constraining the camera to move to different positions on a sphere around the three-dimensional computer model in accordance with user instructions while having a viewing direction towards the centre of the sphere; and
controlling the camera in dependence upon the angle between the viewing direction of the camera and the up axis of the three-dimensional computer model such that:
when the viewing direction of the camera and the up axis of the computer model are perpendicular, the camera is controlled to cause the up axis of the computer model to be parallel to the camera up axis;
when the viewing direction of the camera and the up axis of the computer model are parallel, the camera is not controlled to constrain the relative directions of the camera up axis and computer model up axis; and
when the angle between the viewing direction of the camera and the up axis of the computer model is between 0 degrees and 90 degrees, the relative rotation of the camera and computer model is constrained by an amount dependent upon the angle.

8. A method according to claim 1, claim 6 or claim 7, further comprising performing processing to generate image data defining images of the computer model from the virtual camera.

9. A method according to claim 8, further comprising outputting a signal carrying the image data.

10. A method according to claim 9, further comprising making a recording of the image data by recording the signal either directly or indirectly.

11. Apparatus for generating image data defining views of a three-dimensional computer model from a virtual camera, the apparatus comprising:
a renderer operable to process data defining a three-dimensional computer model and a virtual camera to generate image data defining images of the computer model as viewed from the virtual camera;
an instruction receiver operable to receive user instructions to change the view; and
a controller operable to rotate the virtual camera and computer model relative to each other in accordance with the user instructions;
wherein the controller is arranged to perform additional control of the relative rotations such that:
whenever the viewing direction of the camera and the up axis of the computer model are perpendicular, the up axis of the computer model is constrained to be parallel to the camera up axis; but
whenever the viewing direction of the camera and the up axis of the computer model are parallel, no additional control of the relative rotations is performed.

12. Apparatus according to claim 11, wherein the controller is arranged to perform the additional control of the relative rotations so that the up axis of the camera is constrained towards being parallel to the up axis of the computer model by an amount dependent upon the angle between the viewing direction of the camera and the up axis of the computer model.

13. Apparatus according to claim 12, wherein the controller is arranged to perform the additional control of the relative rotations so that the constraint increases continuously as the angle between the viewing direction of the camera and the up axis of the computer model increases.

14. Apparatus according to claim 12, wherein the controller is arranged to calculate the amount of the constraint in dependence upon the cosine of the angle between the viewing direction of the camera and the up axis of the computer model.

15. Apparatus according to claim 11, wherein the controller is arranged to perform the additional control of the relative rotations by changing the relative rotation of the camera and computer model about the viewing direction of the camera.

16. Apparatus for controlling the relative position and orientation of a virtual camera and a three-dimensional computer model and for generating image data defining images of the computer model as viewed from the virtual camera, the apparatus comprising:
a renderer operable to process data defining a three-dimensional computer model and a virtual camera to generate image data defining images of the computer model as viewed from the virtual camera;
a rotation generator operable to rotate the virtual camera and computer model relative to each other in accordance with user instructions; and
a controller operable to control the relative rotation of the camera and computer model such that:
the user can cause the computer model to spin in displayed images about the up axis of the computer model without the up axis of the computer model deviating from the vertical direction in the images; and
the user can cause the computer model to spin in displayed images about an axis perpendicular to the up axis of the computer model so that the computer model inverts in the images.

17. Apparatus for controlling a virtual camera to view a three-dimensional computer model from different positions in accordance with user instructions, the apparatus comprising:
a renderer operable to process data defining a three-dimensional computer model and a virtual camera to generate image data defining images of the computer model as viewed from the virtual camera;
a camera movement generator operable to constrain the camera to move to different positions on a sphere around the three-dimensional computer model in accordance with user instructions while having a viewing direction towards the centre of the sphere; and
a camera controller operable to control the camera in dependence upon the angle between the viewing direction of the camera and the up axis of the three-dimensional computer model such that:
when the viewing direction of the camera and the up axis of the computer model are perpendicular, the camera is controlled to cause the up axis of the computer model to be parallel to the camera up axis;
when the viewing direction of the camera and the up axis of the computer model are parallel, the camera is not controlled to constrain the relative directions of the camera up axis and computer model up axis; and
when the angle between the viewing direction of the camera and the up axis of the computer model is between 0 degrees and 90 degrees, the relative rotation of the camera and computer model is constrained by an amount dependent upon the angle.

18. Apparatus for generating image data defining views of a three-dimensional computer model from a virtual camera, the apparatus comprising:
means for processing data defining a three-dimensional computer model and a virtual camera to generate image data defining images of the computer model as viewed from the virtual camera;
means for receiving user instructions to change the view; and
control means for rotating the virtual camera and computer model relative to each other in accordance with the user instructions;
wherein the control means is arranged to perform additional control of the relative rotations such that:
whenever the viewing direction of the camera and the up axis of the computer model are perpendicular, the up axis of the computer model is constrained to be parallel to the camera up axis; but
whenever the viewing direction of the camera and the up axis of the computer model are parallel, no additional control of the relative rotations is performed.

19. Apparatus for controlling the relative position and orientation of a virtual camera and a three-dimensional computer model and for generating image data defining images of the computer model as viewed from the virtual camera, the apparatus comprising:
means for processing data defining a three-dimensional computer model and a virtual camera to generate image data defining images of the computer model as viewed from the virtual camera;
means for rotating the virtual camera and computer model relative to each other in accordance with user instructions; and
means for controlling the relative rotation of the camera and computer model such that:
the user can cause the computer model to spin in displayed images about the up axis of the computer model without the up axis of the computer model deviating from the vertical direction in the images; and
the user can cause the computer model to spin in displayed images about an axis perpendicular to the up axis of the computer model so that the computer model inverts in the images.

20. Apparatus for controlling a virtual camera to view a three-dimensional computer model from different positions in accordance with user instructions, the apparatus comprising:
means for processing data defining a three-dimensional computer model and a virtual camera to generate image data defining images of the computer model as viewed from the virtual camera;
means for constraining the camera to move to different positions on a sphere around the three-dimensional computer model in accordance with user instructions while having a viewing direction towards the centre of the sphere; and
means for controlling the camera in dependence upon the angle between the viewing direction of the camera and the up axis of the three-dimensional computer model such that:
when the viewing direction of the camera and the up axis of the computer model are perpendicular, the camera is controlled to cause the up axis of the computer model to be parallel to the camera up axis;
when the viewing direction of the camera and the up axis of the computer model are parallel, the camera is not controlled to constrain the relative directions of the camera up axis and computer model up axis; and
when the angle between the viewing direction of the camera and the up axis of the computer model is between 0 degrees and 90 degrees, the relative rotation of the camera and computer model is constrained by an amount dependent upon the angle.

21. A storage medium storing computer program instructions for programming a programmable processing apparatus to become operable to perform a method as set out in any of claims 1 to 7.

22. A signal carrying computer program instructions for programming a programmable processing apparatus to become operable to perform a method as set out in any of claims 1 to 7.
